(19) United States
(12) Patent Application Publication
(10) Pub. No.: US 2005/0196092 A1
(43) Pub. Date: Sep. 8, 2005

(54) Optical modulator and communications system

(75) Inventors: Akira Enokihara, Nara-shi (JP); Hiroyuki Furuya, Nara-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Matsushita Electric Industrial Co., Ltd.

(21) Appl. No.: 11/113,535

(22) Filed: Apr. 25, 2005

Related U.S. Application Data
(63) Continuation of application No. PCT/JP04/09306, filed on Jun. 24, 2004.

(30) Foreign Application Priority Data
Jun. 26, 2003 (JP) 2003-182115
Nov. 25, 2003 (JP) 2003-393627

(51) Int. Cl. G02F 1/035

(52) U.S. Cl. 385/2; 385/37

(57) ABSTRACT

An optical modulator according to the present invention includes an optical waveguide 2a to 2d made of a material with an electro-optic effect and a modulating electrode 3 for applying a modulating electric signal to light propagating through the optical waveguide 2a to 2d. The modulator further includes a periodic structure, of which the equivalent refractive index changes periodically in a light propagation direction and which can reduce the group velocity of the light propagating through the optical waveguide 2a, 2b.

This is a continuation of International Application PCT/JP2004/009306 and international filing date of Jun. 24, 2004.

### BACKGROUND OF THE INVENTION

1. Field of the Invention

The present invention relates to an optical modulator that can be used effectively in an optical communications system or an optical signal processing system and also relates to a communications system including such an optical modulator.

2. Description of the Related Art

An optical modulator is a basic device for high-speed optical communications and optical signal processing systems. It is expected that there will increasingly high demand for optical modulators, operating at an ultrahigh speed of 30 GHz or more, in the near future.

It is difficult to carry out ultrahigh speed light modulation by a conventional direct modulation technique using a semiconductor laser diode. Thus, an external modulator is currently under vigorous research and development because an element of that type can operate at such high speed. Among other things, an electro-optical modulator, which uses dielectric crystals exhibiting particularly significant Pockel's effect, can operate at such an extremely high speed and yet causes little disturbance in the phase of an optical signal as a result of the optical modulation. For that reason, this electro-optical modulator can be used very effectively in high-speed information transfer, long-range fiber-optics communications and other applications. Also, if an optical waveguide structure is adopted, the modulator may be implemented at a small size and can operate efficiently enough at the same time.

An optical modulator that takes advantage of the electro-optic effect usually includes a conductor transmission line, which functions as a modulating electrode provided on electro-optic crystals and an optical waveguide, which is provided near the conductor transmission line. When a modulating RF signal is supplied to the modulating electrode, the refractive index in a portion of the optical waveguide is changed by an electric field to be induced around the modulating electrode. Then, the phase of a light wave propagating through the optical waveguide changes.

A crystal normally has a relatively small electro-optic coefficient, which is one of fundamental parameters that determine the efficiency of optical modulation. Accordingly, to make such an optical modulator that takes advantage of the electro-optic effect achieve high modulation efficiency, it is important to apply an electric field to the optical waveguide as efficiently as possible.

FIG. 14 is a perspective view illustrating a conventional optical modulator as described in the document IEEE Journal of Quantum Electronics, Vol. QE-13, No. 4, pp. 287-290, 1977. This optical modulator includes an optical waveguide 2a to 2d, which is formed on the surface of a substrate 1 of a crystal material with an electro-optic effect and a modulating electrode 3 for applying a modulating electric signal (i.e., a modulating wave) to the light propagating through the optical waveguide 2a to 2d. The modulating electrode 3 has a coplanar conductor line structure consisting of two mutually parallel conductor lines 3a and 3b.

The optical waveguide 2a to 2d includes an optical input portion 2c, through which light to be modulated (i.e., input light) is input, an optical output portion 2d, through which modulated light is output, and two waveguide branches 2a and 2b, which couple the optical input and output portions 2a and 2d together.

The optical waveguide 2a to 2d is branched into the two waveguide branches 2a and 2b at two branching points 7a and 7b. This modulator is designed such that after the input light that has entered the modulator through the optical input portion 2c has been split into two light beams at one branching point 7a, the two light beams pass through the two waveguide branches 2a and 2b, respectively, are combined together into a single bundle of rays at the other branching point 7b, and then the bundle of rays travels through the common optical output portion 2d.

The internal edge of each of the two conductor lines 3a and 3b that form the modulating electrode 3 is located substantially right over the centerline of its associated waveguide branch 2a or 2b. One terminal of each of these conductor lines 3a and 3b is connected to a modulating RF signal source 4, while the other terminal thereof is connected to a terminal resistor 5.

When an RF signal (i.e., a modulating wave) is supplied from the signal source 4 to the modulating electrode 3, the modulating wave propagates through the modulating electrode 3 in the light propagation direction, thereby generating an electric field in the gap 6. Thus, due to the electro-optic effect, the refractive index of the material of the waveguide branches 2a and 2b changes according to the intensity of the electric field. Electric fields are applied to the waveguide branches 2a and 2b in mutually opposite directions vertically. Accordingly, if the substrate 1 is made of z-cut lithium niobate crystals, for example, the phase modulation produced in the light passing through one of the two waveguide branches 2a and 2b will be quite opposite to that produced in the light passing through the other waveguide branch.

In the optical modulator shown in FIG. 14, the modulating wave propagating through the modulating electrode 3 and the light wave propagating through the optical waveguide 2 travel in the same direction, thus increasing the interaction between the light and signal waves and achieving high-efficiency optical modulation.

However, electro-optic crystals such as lithium niobate crystals have a very small electro-optic constant. Accordingly, even if the modulating electrode 3 were extended to a length of several centimeters, a high voltage of several volts should be applied to the electro-optic crystals to achieve a sufficient degree of modulation. To reduce the overall size of the optical modulator and the required modulating voltage, the interaction between the light wave and the electro-optic material needs to be promoted.

On the other hand, the electro-optic crystals have a refractive index of about 2.1 but also have as high a dielectric constant as about 20 to about 40 with respect to a microwave. Accordingly, the velocity of the light is twice or more higher than that of the microwave. As a result, in such an optical modulator in which light and signal waves are supposed to travel in the same direction, the velocities of these two waves cannot match each other. In that case, no matter how long the modulating electrode is designed, intended modulation cannot be achieved and the efficiency of modulation will deteriorate.

### SUMMARY OF THE INVENTION

In order to overcome the problems described above, a primary object of the present invention is to provide an optical modulator with high modulation efficiency, which can be used effectively in an optical communications system.

An optical modulator according to the present invention includes an optical waveguide made of a material with an electro-optic effect and a modulating electrode for applying a modulating electric signal to light propagating through the optical waveguide. The modulator further includes a periodic structure, of which the equivalent refractive index changes periodically in a light propagation direction and which reduces a group velocity of the light propagating through the optical waveguide.

In one preferred embodiment, the periodic structure is defined by a plurality of recessed portions and/or raised portions that are provided on the surface of the optical waveguide.

In a specific preferred embodiment, the periodic structure is defined by a plurality of grooves cut on the surface of the optical waveguide.

In an alternative preferred embodiment, the periodic structure is defined by a plurality of holes bored on the surface of the optical waveguide.

In another preferred embodiment, the number of the grooves or the holes made on the optical waveguide is 100 or more.

In another preferred embodiment, the depth of the grooves or the holes is at most 50% of the thickness of the waveguide.

In another preferred embodiment, the periodic structure is coated with a dielectric film.

In another preferred embodiment, the periodic structure is defined by a pattern of a dielectric film provided on the optical waveguide.

In another preferred embodiment, the periodic structure includes a first region and a second region, which are arranged in series in the light propagation direction, and an intermediate region, which is located between the first and second regions.

In another preferred embodiment, a period in which the equivalent refractive index of the periodic structure changes in the light propagation direction is set to a numerical value that is a quarter to a half as long as the wavelength λ of the light to be modulated in the optical waveguide. Alternatively, a period in which the equivalent refractive index of the periodic structure changes in the light propagation direction may also be set to a product of the numerical value and an odd number.

In another preferred embodiment, the length of the intermediate region as measured in the light propagation direction is either approximately ½ λ or an integral multiple of ½ λ.

In another preferred embodiment, the optical waveguide includes: an optical input portion to input the light to be modulated; an optical output portion to output the modulated light; and at least two waveguide branches that couple the optical input and output portions together. The modulating electrode includes at least two conductor lines for applying the modulating electric signal to the light propagating through the respective waveguide branches. The intensity of the light is modulated by utilizing the interference of the light, which has propagated through the respective waveguide branches, at the optical output portion.

In an alternative preferred embodiment, the optical waveguide is a single optical waveguide with one end to input the light to be modulated and the other end to output the modulated light. The modulating electrode includes at least two conductor lines for applying the modulating electric signal to the optical waveguide. The phase of the light that has propagated through the optical waveguide is modulated according to the modulating electric signal.

In another preferred embodiment, the optical waveguide is defined on an electro-optic crystal substrate.

In another preferred embodiment, the optical waveguide is defined as a ridge on the surface of the electro-optic crystal substrate.

In another preferred embodiment, the optical waveguide is made of an electro-optic material supported on a substrate.

In another preferred embodiment, the group velocity of the light propagating through the optical waveguide is adjusted to 0.5 to 2 times as high as the phase velocity of a radio frequency wave transmitted through the electrode.

In another preferred embodiment, the group velocity of the light propagating through the optical waveguide is reduced to 50% or less of that of the light propagating through an optical waveguide without the periodic structure.

A communications system according to the present invention includes any of the optical modulators described above, an optical fiber for transmitting the modulated light that has been output from the optical modulator and means for supplying the modulating electric signal to the optical modulator.

### BRIEF DESCRIPTION OF THE DRAWINGS

FIG. 1 is a perspective view illustrating a first preferred embodiment of an optical modulator according to the present invention.

FIG. 2(a) is a plan view of the optical modulator shown in FIG. 1; FIG. 2(b) is an enlarged view of its area A; and FIG. 2(c) is a cross-sectional view of the area A.

FIG. 3(a) is a cross-sectional view illustrating a periodic structure model to be used to calculate a group velocity in the first preferred embodiment of the present invention; FIG. 3(b) shows the light transmittance characteristic of the periodic structure model; and FIG. 3(c) is a graph showing the time delay of a light wave propagating through this periodic structure model.

FIG. 4(a) is a plan view illustrating a second preferred embodiment of an optical modulator according to the present invention; FIG. 4(b) is an enlarged plan view of its area A; and FIG. 4(c) is an enlarged cross-sectional view of the area A.

FIG. 5 is a plan view illustrating a third preferred embodiment of an optical modulator according to the present invention.

FIG. 6(a) is a plan view illustrating a fourth preferred embodiment of an optical modulator according to the present invention; FIG. 6(b) is an enlarged plan view of its area A; FIG. 6(c) is an enlarged cross-sectional view of the area A; and FIG. 6(d) is an enlarged cross-sectional view of an area A in a different shape.

FIG. 7(a) is a plan view illustrating a fifth preferred embodiment of an optical modulator according to the present invention, and FIG. 7(b) is a cross-sectional view thereof as viewed on a plane A-A′.

FIG. 8 is a plan view illustrating an etching mask for use in the fifth preferred embodiment.

FIG. 9 is a cross-sectional view illustrating a ridged waveguide according to the fifth preferred embodiment.

FIG. 10 is a cross-sectional view of the ridged waveguide of the fifth preferred embodiment as viewed on a plane that is parallel to the length direction thereof.

FIGS. 11(a) through 11(c) are cross-sectional views of various substrates with a ridged waveguide.

FIG. 12 is a perspective view illustrating a ridged waveguide in which recessed portions are arranged.

FIG. 13 is a diagram showing a preferred embodiment of a communications system according to the present invention.

FIG. 14 is a perspective view illustrating a conventional optical modulator.

### DETAILED DESCRIPTION OF PREFERRED EMBODIMENTS

Hereinafter, preferred embodiments of the present invention will be described with reference to the accompanying drawings.

Embodiment 1

A first preferred embodiment of an optical modulator according to the present invention will be described.

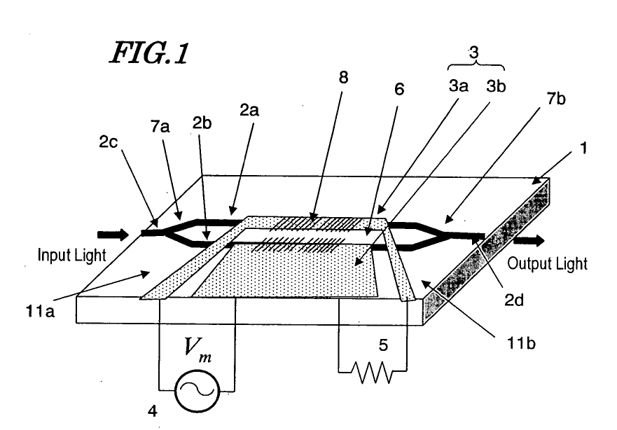

First, referring to FIG. 1, illustrated is an optical modulator according to this preferred embodiment, which includes an optical waveguide 2a to 2d made of a material with an electro-optic effect and a modulating electrode 3 for applying a modulating electric signal (which will be referred to herein as a “modulating wave”) to a light wave propagating through the optical waveguide 2a to 2d. The optical modulator of this preferred embodiment is characterized by further including a periodic structure, of which the equivalent refractive index changes periodically in the light propagation direction. This prominent feature will be described more fully later.

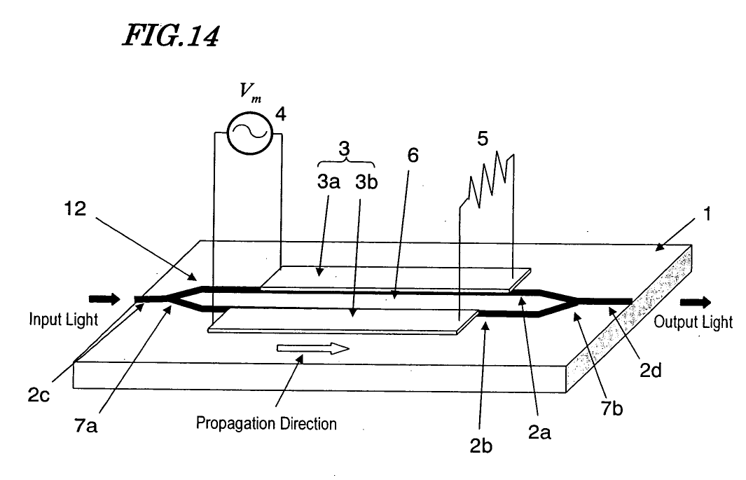

Just like the conventional optical modulator described above with reference to FIG. 14, the optical waveguide 2a to 2d of this preferred embodiment also includes an optical input portion 2c, through which the light to be modulated (input light) is input, an optical output portion 2d, through which the modulated light is output, and two waveguide branches 2a and 2b that connect the optical input and output portions 2c and 2d together. The input light that can be modulated by the optical modulator of this preferred embodiment may have a wavelength falling within the range of 0.6 μm to 1.5 μm, for example.

The optical waveguide 2a to 2d of this preferred embodiment is built in the surface portion of a substrate 1 with an electro-optic effect. That is to say, to confine the light vertically to the principal surface of the substrate 1, the optical waveguide 2a to 2d is designed as a region with an increased refractive index as compared with the remaining region. The optical waveguide 2a to 2d may have a thickness (as measured perpendicularly to the principal surface of the substrate 1) of 1 μm to 5 μm, for example. It should be noted that the substrate 1 is made of an electro-optic material such as lithium tantalate (LiTaO₃) single crystals or lithium niobate (LiNbO₃) single crystals.

The optical waveguide 2a to 2d may be provided on a selected area of the upper surface of the substrate 1 by either a proton exchange process using benzoic acid or a thermal diffusion process of metal titanium. In any case, such a process may be carried out after the upper surface of the substrate 1 has been covered with a mask having an opening that defines the planar layout of the optical waveguide. By changing the layout of the mask opening, an optical waveguide of any arbitrary shape can be formed.

In this preferred embodiment, the optical waveguide 2a to 2d is divided into two waveguide branches 2a and 2b at two branching points 7a and 7b. Accordingly, incoming light is input through the optical input portion 2c and then split into two light beams at the former branching point 7a. Next, the two light beams propagating through the two waveguide branches 2a and 2b, respectively. In the meantime, the light beams propagating through the optical waveguide branches 2a and 2b are subject to modulation by the modulating electrodes 3a and 3b. Then, the light beams are combined together at the latter branching point 7b. Thereafter, the combined light travels through the common optical output portion 2d, when its intensity is modulated due to interference.

The modulating electrode 3 of this preferred embodiment is an asymmetric coplanar electrode and includes two conductor lines 3a and 3b for applying a modulating electric signal (e.g., an RF signal with a frequency of 1 GHz to 100 GHz) to the light beams propagating through the waveguide branches 2a and 2b. Of these two conductor lines 3a and 3b extending along the waveguide branches 2a and 2b, the conductor line 3a functions as a hot electrode while the conductor line 3b functions as a ground electrode.

The conductor lines 3a and 3b are arranged such that the inner edge of each of the conductor lines 3a and 3b is located substantially right over the centerline of its associated waveguide branch 2a or 2b. Both ends of each of these conductor lines 3a and 3b extend toward the side surfaces of the substrate 1. One terminal of each of these conductor lines 3a and 3b is connected to a signal source 4, while the other terminal thereof is connected to a terminal resistor 5. More specifically, the one terminal of the conductor line 3a and the signal source 4 are connected together with an input/output conductor line 11a, while the other terminal of the conductor line 3a and the terminal resistor 5 are connected together with an input/output conductor line 11b.

These conductor lines 3a and 3b and input/output conductor lines 11a and 11b may be obtained by depositing a conductive thin film on the substrate 1 by a thin film deposition technique such as an evaporation process and then patterning that thin film by photolithographic and etching techniques. A conductive thin film like this is preferably made of gold, aluminum or any other suitable metal.

The light that has been input through the optical input portion 2c is subjected to the following modulation while passing through the respective waveguide branches 2a and 2b.

First, when an external driver circuit applies a modulating electric signal (with a frequency of 1 GHz to 100 GHz) to the input conductor line 11a, the modulating signal propagates through the respective conductor lines 3a and 3b of the modulating electrode 3, thereby generating an electric field in the gap 6 between the conductor lines 3a and 3b. When this electric field reaches a portion of the electro-optic material that makes the waveguide branches 2a and 2b, the refractive index of that portion changes due to the electro-optic effect. The degree of dynamic variation in refractive index changes according to the intensity of the electric field acting on the waveguide branches 2a and 2b.

In this preferred embodiment, upward and downward electric fields are applied to the waveguide branches 2a and 2b. That is to say, electric fields are applied to these portions 2a and 2b in mutually opposite directions. Accordingly, if the substrate 1 is made of z-cut lithium niobate crystals, for example, the phase shift produced in the light being transmitted through one waveguide branch 2a will be reverse to that produced in the light being transmitted through the other waveguide branch 2b. As a result, at the optical output portion 2d, the light beams that have been transmitted through the two waveguide branches 2a and 2b interfere with each other. This interference changes the intensity of the outgoing light eventually. In this manner, the optical modulator of this preferred embodiment operates as a light intensity modulator.

In this preferred embodiment, a periodic structure is provided for the waveguide branches 2a and 2b as described above, thereby decreasing the group velocity of the light waves.

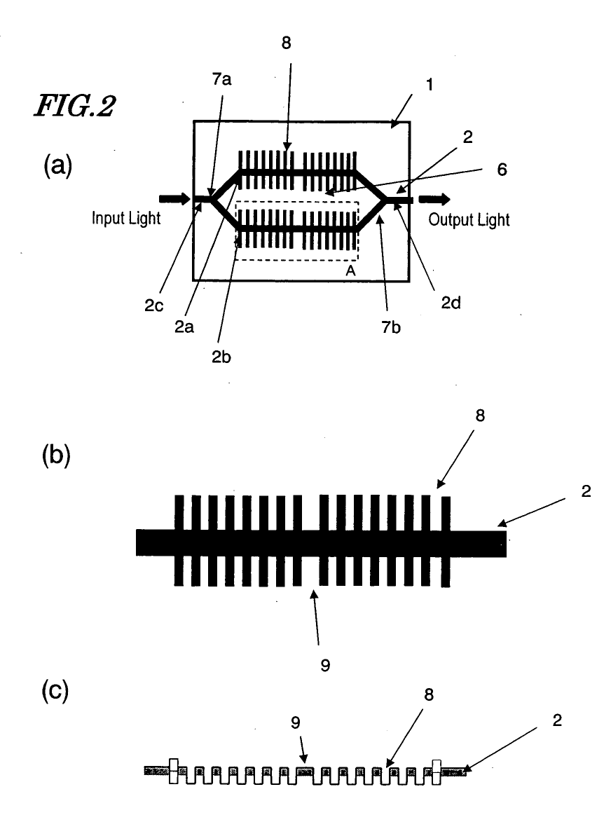

Hereinafter, this periodic structure will be described in detail with reference to FIGS. 2(a) through 2(c). FIG. 2(a) is a plan view of the optical modulator shown in FIG. 1. FIG. 2(b) is a plan view illustrating its area A on a larger scale. And FIG. 2(c) is a cross-sectional view of the area A shown in FIG. 2(b).

In FIG. 2(a) , the illustration of the modulating electrode 3 is omitted and the overall optical waveguide 2a to 2d is identified by the reference numeral 2 for the sake of simplicity. The periodic structure is provided for each of these two waveguide branches 2a and 2b. Thus, only the periodic structure defined in the area A of one waveguide branch 2b will be described.

The periodic structure of this preferred embodiment is defined by a plurality of grooves 8 as shown in FIGS. 2(b) and 2(c). More specifically, this periodic structure is roughly divided into two regions that are arranged in series in the light propagation direction (which will be referred to herein as a “first region” and a “second region”, respectively), and an intermediate region 9 is provided between the first and second regions.

In the first and second regions, grooves 8 that are deep enough to cross the optical waveguide 2 completely are arranged as a periodic pattern. For that reason, a light wave traveling rightward (i.e., from left to right) through the optical waveguide 2 alternately transmits through the substrate material portions that make the optical waveguide and the voids of those grooves. In this case, the light wave feels the refractive index change alternately and periodically between the substrate material portions and the groove voids. Unless the upper surface of the substrate 1 is covered with a dielectric film, the voids of the groove 8 are filled with the air. Accordingly, the refractive index in the grooves 8 is equal to that of the air (i.e., approximately one). On the other hand, if the substrate is made of LiNbO₃, then the substrate material portions have a refractive index of about 2.1. However, the refractive index of the substrate material portions changes with the substrate material adopted and with the intensity of the modulating electric field applied to the optical waveguide.

A period in which the equivalent refractive index of the periodic structure changes in the first and second regions (i.e., in the light propagation direction) is set to a quarter to a half as long as the wavelength λ of the light to be modulated in the optical waveguide. If the grooves 8 have a period of about ½ λ, then the grooves 8 preferably have a width of about ¼ λ. In the intermediate region 9, this periodic variation in refractive index discontinues. The size of the intermediate region 9 as measured in the light propagation direction is preferably set to about ½ λ but may also fall within the range of 0.4 λ to 0.6 λ. Alternatively, the period and width of the grooves 8 in the first and second regions may also be set to a product of this magnitude and an odd number. Even so, similar effects are also achieved. Furthermore, the size of the intermediate region 9 as measured in the light propagation direction may be an integral multiple of ½ λ because similar effects are achievable in that situation, too.

In this preferred embodiment, eight grooves 8 are arranged at regular intervals in each of the first and second regions. However, the periodic variation in the equivalent refractive index may also be produced without arranging those grooves. For example, either a plurality of raised portions or a plurality of recessed portions (such as holes) may be arranged on the surface of the substrate 1. As another alternative, recessed portions and raised portions may be arranged in combination, too.

The grooves 8 adopted in this preferred embodiment may be defined by etching the surface of the substrate 1. More specifically, after the surface of the substrate 1 has been coated with a photoresist layer, the photoresist layer may be subjected to development and exposure by a known photolithographic process, thereby obtaining a resist mask that has a plurality of openings defining the arrangement pattern of the grooves. Next, portions of the substrate, which are exposed through the openings of the resist mask, may be etched away, thereby forming the grooves 8 on the surface of the substrate 1. The depth of the grooves 8 can be adjusted by controlling the conditions of this etching process. Also, the width and period (i.e., arrangement pitch) of the grooves 8 may be arbitrarily defined by the pattern of the resist mask to be obtained by the photolithographic process.

If the substrate 1 is made of a material with an electro-optic effect such as LiNbO₃, the etching process to define the grooves 8 may be carried as a fluorine gas plasma reactive ion etching (RIE) process or an inductively coupled plasma (ICP) etching process. In performing an ICP process, the substrate 1 may be etched at a rate of 0.5 μm/min by using a highly reductive gas such as CF₄, BCl₃ or C₄F₈ gas. According to this method, a selectivity of one is achieved with respect to a photoresist.

It is already known that an element obtained by stacking a plurality of dielectric layers with a thickness of ¼ λ each with thin films having a thickness of ½ λ interposed between them operates as a wavelength filter. Such a wavelength filter can produce resonance with respect to light having a particular wavelength. In the optical modulator of this preferred embodiment, a plurality of grooves 8 are arranged periodically along the optical waveguide 2, thereby making the light with a particular wavelength λ produce resonance in the optical modulator and decreasing the group velocity of the light waves propagating through the optical waveguide. The number of the grooves 8 provided on the single optical waveguide is at least 100, and preferably 1,000 or more.

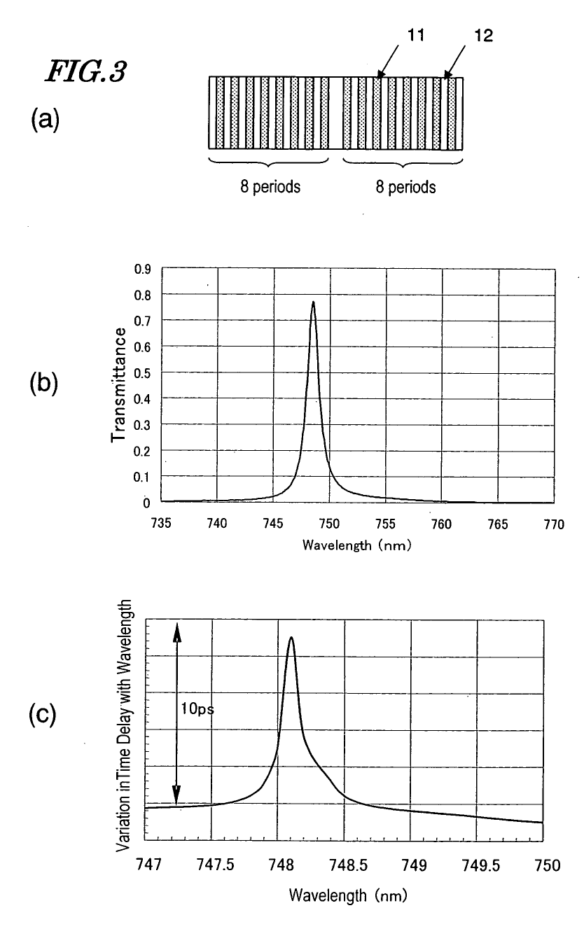

Next, it will be described with reference to FIGS. 3(a) through 3(c) how effectively the group velocity can be reduced by the periodic structure of this preferred embodiment.

The portion of the optical waveguide 2 with the grooves 8 can be regarded as optically equivalent to the structure of a multilayer dielectric filter in which a plurality of layers 11 and 12 with different refractive indices are stacked one upon the other as shown in FIG. 3(a). Using a model with this equivalent structure, the group velocity of light waves propagating through the optical waveguide of this preferred embodiment was calculated. Specific parameters of this model were as follows:

Layers 11 were made of an electro-optic material (e.g., LiNbO₃) with a refractive index of 2.1 and with a thickness of 89 nm,

Layers 12 were made of a material (e.g., SiO₂) with a low refractive index of 1.5 and a thickness of 125 nm, and

Intermediate layer was made of a material (e.g., SiO₂) with a low refractive index of 1.5 and a thickness of 250 nm.

The eight-period multilayer structure corresponds to each of the first and second regions of this preferred embodiment, while the intermediate layer corresponds to the intermediate region 9.

FIGS. 3(b) and 3(c) are graphs showing the results of calculations. Specifically, FIG. 3(b) shows the light transmittance characteristic of the periodic structure shown in FIG. 3(a) and FIG. 3(c) shows the time delay of a light wave propagating through this periodic structure. In each of these graphs, the abscissa represents the wavelength of the light wave.

The time it takes a light wave to be propagating through a continuous space having the average refractive index of the periodic structure described above calculates about 0.02 picoseconds (ps). On the other hand, the maximum time delay caused by a light wave transmitted through the periodic structure shown in FIG. 3(a) reaches about 10 ps as can be seen from FIG. 3(c).

Thus, by providing a periodic structure such as that shown in FIG. 3(a) within the optical waveguide, the time delay caused by a light wave can be increased about 500 times, which means that the group velocity of light waves can be reduced to 1/500 and that the effective optical path length becomes about 500 times as long as the actual optical path length.

By providing the periodic structure as shown in FIGS. 3(a) through 3(c) for the optical modulator of this preferred embodiment, the effective optical path length can be several hundreds of times as long as the actual one without increasing the real size of the element. As a result, the efficiency of modulation can be increased significantly. More specifically, although a conventional optical modulator needs to have a length of at least several centimeters, the optical modulator of this preferred embodiment may have a length of just several millimeters.

Embodiment 2

Hereinafter, a second preferred embodiment of an optical modulator according to the present invention will be described.

The optical modulator of this preferred embodiment has the same configuration as the counterpart of the first preferred embodiment described above except the periodic structure provided for the optical waveguide. Thus, the following detailed description will be focused on the periodic structure of this preferred embodiment but the other portions will not be described again.

As mentioned above, the depth, width and interval of the grooves 8 are controllable by adjusting the specific pattern of the etching mask and the conditions of the etching process. And by modifying the depth, width and interval of the grooves 8, the group velocity characteristic of the light waves propagating through the optical waveguide 2 can be controlled.

Supposing the free space velocity of a light wave is represented by v₀ and the refractive index of an optical waveguide is represented by n, the group velocity of light waves propagating through an optical waveguide with no grooves 8 would be approximately equal to v₀/n. However, by providing the grooves 8 for the optical waveguide, the group velocity of light waves propagating through the optical waveguide can be smaller than v₀/n.

In this preferred embodiment, the group velocity of light waves propagating through the optical waveguide 2 is matched to the phase velocity of a modulating electric signal applied to the electrode for optical modulation purposes.

Lithium niobate, which is extensively used as the material of a substrate consisting of electro-optic crystals, has a refractive index n of about 2. Accordingly, the group velocity of light waves propagating through an optical waveguide that is built in such an electro-optic crystal substrate becomes approximately equal to 0.5 v₀.

On the other hand, the phase velocity of the modulating wave propagating through the modulating electrode 3 is represented approximately by 2 v₀/(1+εᵣ^{1/2}) , where εᵣ is the relative dielectric constant of the substrate 1. If the substrate 1 is made of lithium niobate crystals, the relative dielectric constant εᵣ thereof is about 31 considering the anisotropy of those crystals. Accordingly, the phase velocity of the modulating wave propagating through the modulating electrode 3 is approximately equal to 0.3 v₀.

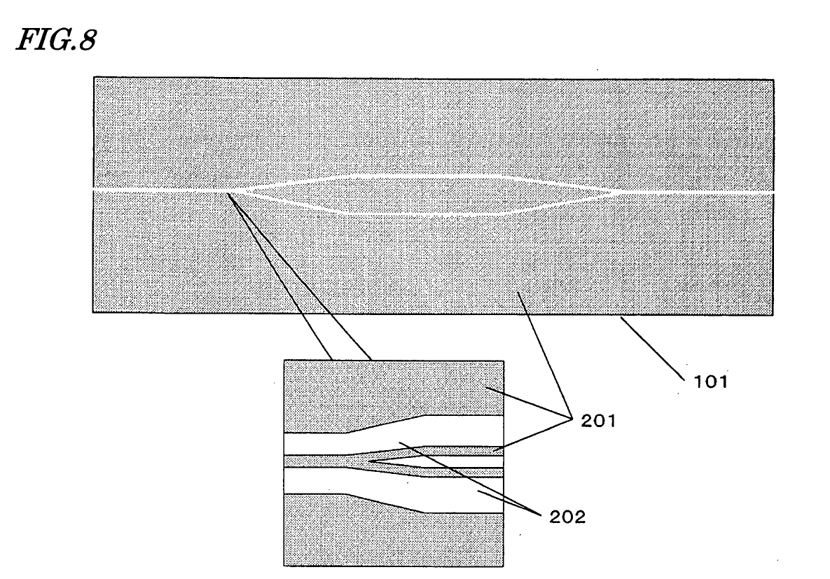

As can be seen, in an ordinary optical waveguide 2 with no grooves 8, the group velocity of light waves can be about twice as high as the phase velocity of the modulating wave. Such a velocity difference leads to a decrease in optical modulation efficiency. In the conventional optical modulator shown in FIG. 8, for example, the light waves are propagating through the optical waveguide at a group velocity that is twice higher than the velocity of the modulating wave. Accordingly, a light wave, which was input to the optical waveguide at a time t1, senses more and more strongly the electric field generated by a modulating wave that had been input at a time t0, which is anterior to the time t1 (i.e., t0<t1), as the light wave goes farther along the optical waveguide. The polarity of the electric field, generated by the modulating wave and sensed by the light wave input to the optical waveguide, inverts when the propagation distance exceeds a certain length. As a result, the phase modulation produced in the light wave is canceled.

In this preferred embodiment, by adjusting the depth, width and interval of the grooves 8 provided for the optical waveguide 2, the group velocity of the light waves propagating through the optical waveguide 2 is reduced adequately so as to substantially match the phase velocity of the modulating wave. Accordingly, even if the area A of the optical waveguide is designed longer than the conventional one, the interaction length can still be extended and the modulation efficiency can be improved significantly while avoiding the cancellation of the phase modulation due to the velocity difference.

In the prior art, to increase the phase velocity of the modulating wave and thereby reduce such a big velocity difference, a shield plate may be arranged over the modulating electrode 3 or the thickness of the modulating electrode 3 is significantly increased to several μm.

In contrast, the prominent feature of the optical modulator of the present invention is to reduce the group velocity of light waves propagating through the optical waveguide 2, instead of increasing the phase velocity of the modulating wave, and thereby match these two velocities with each other. In this preferred embodiment, the group velocity of the light waves is reduced by providing relatively shallow grooves 8 on the optical waveguide 2.

In addition, according to this preferred embodiment, the velocities can be matched by decreasing the group velocity of the light waves, and therefore, the length of the element can be shortened and the overall size of the element can be reduced as compared with a conventional one.

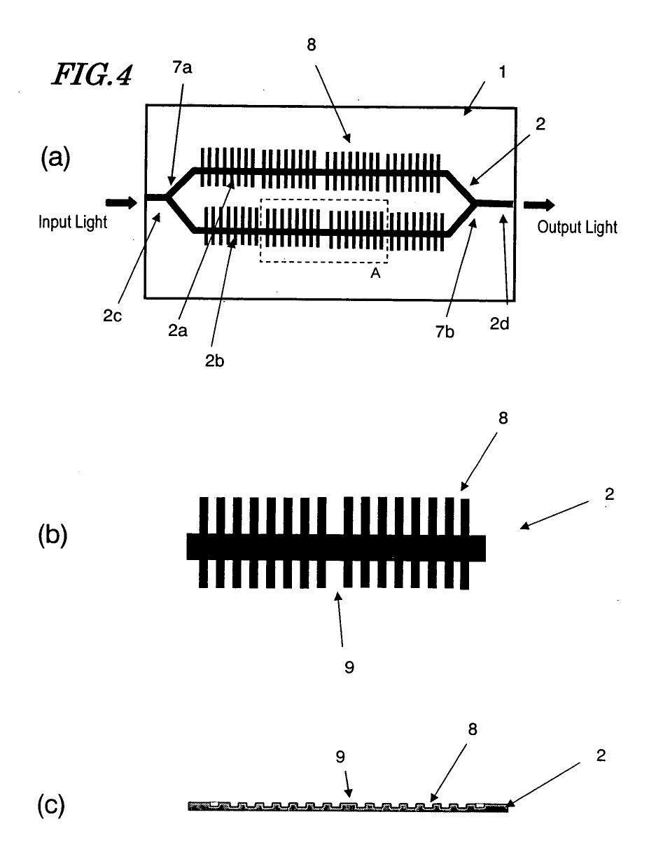

In this preferred embodiment, four unit regions, in each of which the grooves 8 are provided in a period of a half wavelength, are arranged in series along the respective waveguide branches 2a and 2b as shown in FIG. 4(a). FIG. 4(b) illustrates the arrangement of the area A shown in FIG. 4(a) among these lines of unit regions. As shown in FIG. 4(b), a plurality of unit regions are arranged in series with the intermediate region 9 interposed between them, thereby providing a portion with a low group velocity over a long distance. In FIGS. 4(a) and 4(b), four unit regions are provided along each waveguide branch. However, an even greater number of unit regions may be provided there, too.

The depth of the grooves 8 is adjusted according to the target characteristic of the optical modulator. If the grooves 8 were too shallow, then the group velocity of the light waves propagating through the optical waveguide would not be reduced sufficiently, and therefore, it would be harder to match the velocities of the modulating wave and the light waves. For that reason, the depth of the grooves 8 is preferably defined at least equal to 5% of the thickness of the optical waveguide. Optionally, the group velocity of the light waves may be reduced by adopting the periodic structure of the present invention and the phase velocity of the modulating wave may be increased by a known method at the same time. In that case, the depth of the grooves 8 may be at least equal to 20% of the thickness of the optical waveguide.

It should be noted that the depth of the grooves 8 may be at most equal to, and does not have to be beyond, a depth (which is usually about 5 μm) where the electromagnetic field of the light waves propagating through the optical waveguide is present. Optionally, however, the grooves 8 may be deep enough to exceed that level. In the first preferred embodiment described above, the depth of the grooves 8 is defined greater than the thickness of the optical waveguide as shown in FIG. 2(c), and therefore, the amplitude of the variation in equivalent refractive index is maximized. If such deep grooves 8 were cut on the optical waveguide, then the group velocity of the light waves would be far lower than the phase velocity of the modulating wave and it would be virtually impossible to match these two velocities.

That is why if the velocities need to be matched with each other as is done by the optical modulator of this preferred embodiment, then relatively shallow grooves 8 should be provided. If the grooves 8 are cut to a depth that is a half of the thickness of the optical waveguide, for example, then the light wave propagating through the optical waveguide will sense an effective refractive index, which is determined by the refractive index inside of the grooves 8 and that of the substrate material located under the grooves 8. The shallower the grooves 8 are, the more significantly the substrate material contributes and the closer to the refractive index of the substrate material the effective refractive index gets. Stated otherwise, the deeper the grooves 8 are, the less significantly the substrate material contributes and the closer to the refractive index inside of the grooves 8 (i.e., the refractive index of either the air or a dielectric material filling the grooves 8) the effective refractive index gets.

In this preferred embodiment, to match the group velocity of the light waves with the phase velocity of the modulating wave, the depth of the grooves is defined smaller than the thickness of the optical waveguide (i.e., the thickness of the region with the higher refractive index). However, even if the group velocity of the light waves is set sufficiently lower than the phase velocity of the modulating wave as is done by the optical modulator of the first preferred embodiment, the groove depth may also be defined smaller than the thickness of the optical waveguide. If the grooves are shallow, then the fine line patterning process for cutting those grooves can be carried out more easily and the etching process can be performed in a shorter time. Even if the groove depth (or the depth of holes to be described later) is 50% or less of the thickness of the optical waveguide (i.e., the region with the higher refractive index), the group velocity of the light wave can still be reduced sufficiently.

Embodiment 3

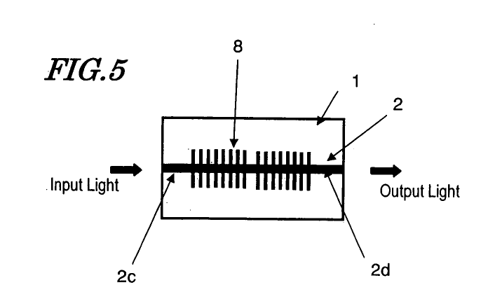

Hereinafter, a third preferred embodiment of an optical modulator according to the present invention will be described with reference to FIG. 5.

Each of the preferred embodiments described above includes a Mach-Zehnder interferometer type optical waveguide and functions as a light intensity modulator that takes advantage of interference. On the other hand, the optical modulator of this preferred embodiment includes a single optical waveguide 2, along which the same grooves 8 as the counterparts of the preferred embodiments described above are arranged as shown in FIG. 5.

The optical modulator of this preferred embodiment can also reduce the group velocity of the light waves propagating through the optical waveguide 2. Thus, by getting a modulating electric field applied from a modulating electrode (not shown) to the optical waveguide 2, the optical modulator can operate as a small-sized optical phase modulator with high modulation efficiency. Even an optical modulator with such an optical waveguide structure can also achieve the above effects by reducing the group velocity of the light waves.

Embodiment 4

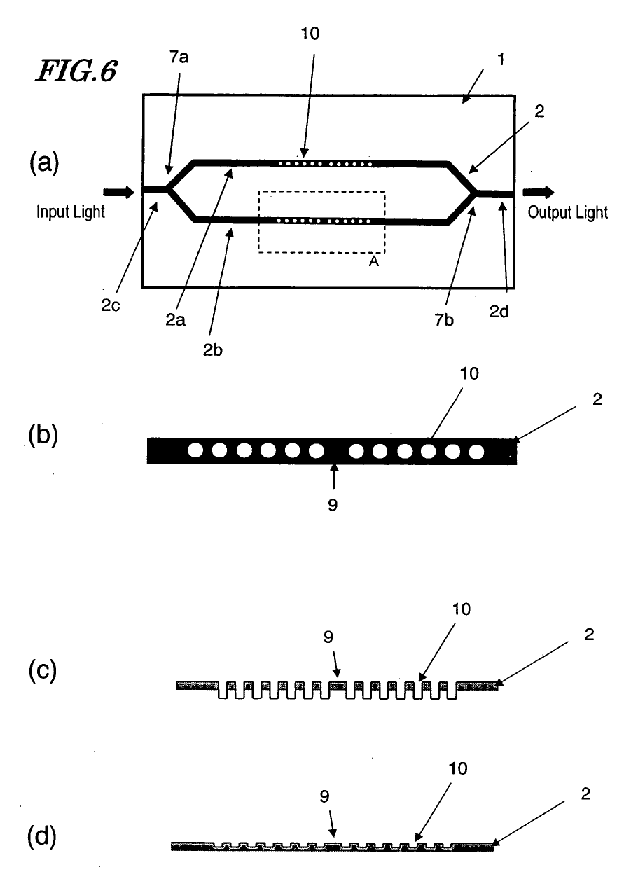

Hereinafter, a fourth preferred embodiment of an optical modulator according to the present invention will be described with reference to FIGS. 6(a) through 6(d).

As shown in FIG. 6(a), the optical modulator of this preferred embodiment basically has the same configuration as the first or second preferred embodiment described above. The main difference between this and other preferred embodiments is that the periodic structure of this preferred embodiment is defined by holes, not grooves.

The periodic structure of this preferred embodiment will be described more fully.

As shown in FIG. 6(a), a plurality of holes 10 are bored in each waveguide branch 2a, 2b. These holes 10 have the same function as the grooves 8. Thus, by adjusting the number, width, period and depth of the holes 10, the group velocity of the light waves can be controlled appropriately. If relatively shallow holes 10 are made as shown in FIG. 6(d), the velocities of the light waves and the modulating wave can be matched with each other. On the other hand, if relatively deep holes 10 are made as shown in FIG. 6(c), then the group velocity of the light waves can be reduced to a several hundredths compared with the situation where no holes 10 are cut open. In that case, a small-sized optical modulator with a considerably short element length can be obtained.

The holes 10 preferably have a diameter of about ¼ λ and are preferably arranged in a period of about ½ λ. The intermediate region 9 preferably has a length of about ½ λ. By providing such a periodic structure, the group velocity of light waves with a wavelength λ can be reduced with low loss.

According to this preferred embodiment, the same effects as those of the first or second preferred embodiment are also achieved by arranging a plurality of holes 10 periodically along the optical waveguide. Thus, the periodic structure can be defined by using a simpler mask pattern than that used for cutting the grooves.

It should be noted that the cross section of the holes as viewed on a plane parallel to the principal surface of the substrate 1 does not have to be circular but may also be elliptical or polygonal as well. Also, the cross section of the holes as viewed on a plane perpendicular to the principal surface of the substrate does not have to be rectangular but may also be upwardly or downwardly tapered. Furthermore, the holes are arranged in line along each waveguide branch in this preferred embodiment. Alternatively, the holes may also be arranged either in a number of lines or in a winding pattern with respect to each waveguide branch.

Embodiment 5

In each of the preferred embodiments described above, the optical waveguide is built in the flat upper surface of the substrate. However, the present invention is in no way limited to those specific preferred embodiments. Optionally, the optical waveguide may also be cut as ridges on upper surface of the substrate.

Hereinafter, a preferred embodiment of an optical modulator including a substrate with such a ridged waveguide will be described.

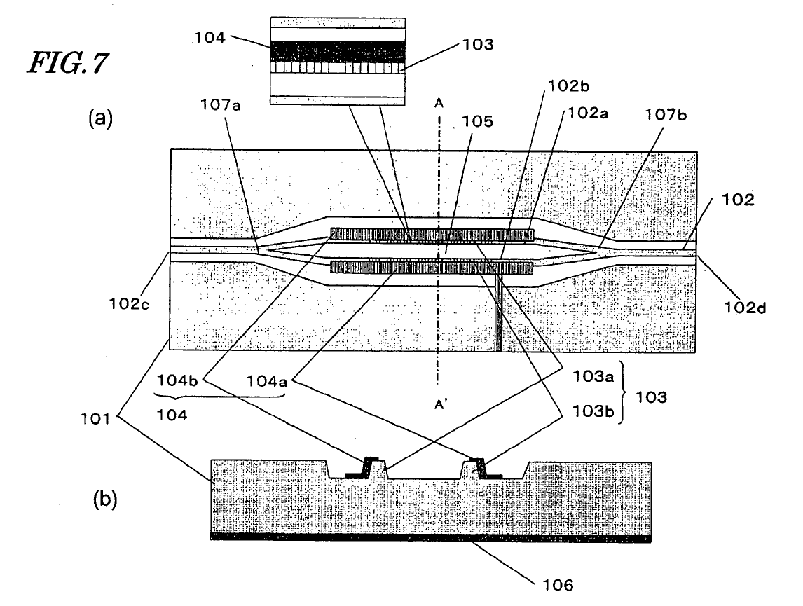

First, referring to FIGS. 7(a) and 7(b), illustrated are a top view of an optical modulator according to this preferred embodiment and a cross-sectional view thereof as viewed on an A-A′ plane, respectively.

In this preferred embodiment, an optical waveguide 102, patterned as ridges by an etching process, is built in the surface of a substrate 101. Just like the substrate of the other preferred embodiments, the substrate 101 may also be made of a material with an electro-optic effect such as lithium tantalate (LiTaO₃) single crystals or lithium niobate (LiNbO₃) single crystals. In this preferred embodiment, the substrate 101 is made of an LiNbO₃ wafer, which was cut on a plane perpendicular to the z-axis (i.e., z plane).

The optical waveguide 102 is branched into two waveguide branches 102a and 102b at two branching points 107a and 107b. Accordingly, incoming light is input through the optical input portion 102c and then split into two light beams at the former branching point 107a. Next, the two light beams are propagating through the two waveguide branches 102a and 102b, respectively. Then, the light beams are combined together at the latter branching point 107b and the combined light travels through the common optical output portion 102d. In this manner, this optical waveguide operates as a Mach-Zehnder interferometer.

The ridged optical waveguide portions 102a and 102b respectively have periodic structures 103a and 103b, in each of which a number of grooves are arranged periodically and which are partially covered with a modulating electrode 104.

If the modulation needs to be done in a high frequency range such as a milliwave band by using the optical modulator of this preferred embodiment, then the substrate 101 preferably has a thickness of 50 μm to 300 μm to minimize unnecessary resonance of an electromagnetic field in the substrate 101. In that case, instead of using an overall thin substrate 101, a portion of the substrate 101 may be etched deep so as to have a thickness of 10 μm to 200 μm.

The substrate 101 may be prepared in the following manner, for example. First, after an LiNbO₃ wafer has been washed, metal Ti may be deposited to a thickness of about 50 nm, for example, on the surface of the LiNbO₃ wafer with an electron beam evaporation system. Thereafter, the LiNbO₃ wafer is heated to, and maintained at, 1,000° C. for approximately 10 hours, thereby diffusing Ti to a depth of about 1 μm to about 5 μm (e.g., 3 μm) as measured from the surface of the wafer. By performing this process step, a region that can function as an optical waveguide (i.e., a region with the higher refractive index) can be defined just below the surface of the wafer. A refractive index difference of about 0.02 (i.e., Δn 0.02) is created in the boundary between the Ti-diffused region and non-Ti-diffused region.

Thereafter, an etching mask (e.g., a photoresist mask) 201 having a shape that defines the planar layout of the ridged waveguide portions is provided on the wafer as shown in FIG. 8. Next, the surface of the wafer is selectively etched away through the openings 202 of the mask by a dry etching process using a fluorine gas and argon gas, thereby cutting the ridged optical waveguide 102 under the etching mask 201. This etching process may be carried out in the same way as the etching process for cutting the grooves 8 or the holes 10 as described above.

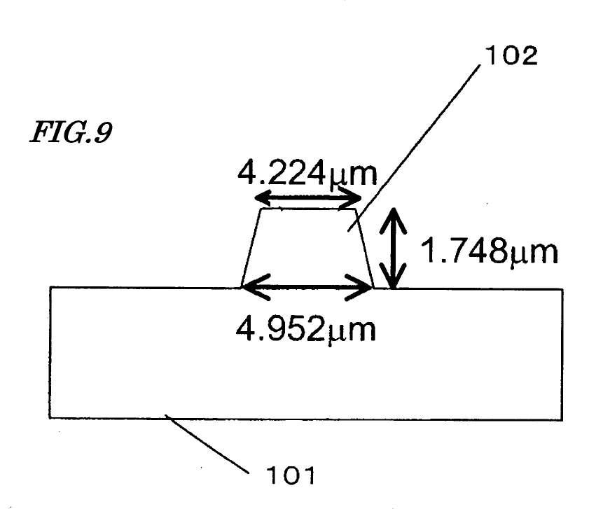

FIG. 9 schematically illustrates a cross section of a single ridged optical waveguide 102. The ridged waveguide to be cut in this preferred embodiment may have a width (i.e., a ridge width) of about 5 μm and a height (i.e., a ridge height) of about 2 μm, for example. In that case, the whole ridged waveguide is the region with the higher refractive index in which Ti has diffused. However, if the ridge height is set greater than the thickness of the region with the higher refractive index, then the upper portion of the ridged wafer surface functions as an optical waveguide.

To increase the coupling efficiency with light, the ridge width is preferably defined at least equal to 1 μm. However, to propagate the light in the single mode through the optical waveguide, the ridge width is preferably defined 6 μm or less. Meanwhile, the ridge height is defined so as to fall within the range of 1 μm to 20 μm, for example.

It should be noted that not all of the optical waveguide has to have the ridge shape but only a portion thereof, which should have the periodic structure, may be patterned into the ridge shape. Alternatively, a recess may be cut on the surface of the wafer by selectively etching away only an internal region thereof that is sandwiched between the two optical waveguide branches. In that case, the gap between the two optical waveguide portions can be narrowed, thus increasing the electric field applied and the modulation efficiency.

After the ridged waveguide has been cut by such a method, the periodic structure is defined by subjecting the ridged waveguide to a fine line patterning process to be carried out similarly to the process of cutting the ridged waveguide. In this preferred embodiment, a number of grooves are cut on the ridged optical waveguide 102 so as to be arranged periodically in the length direction of the waveguide. The grooves may have a depth of 600 nm, a width of 5 μm and an interval of 3 μm, respectively. The groove depth may be either smaller or greater than the ridge height.

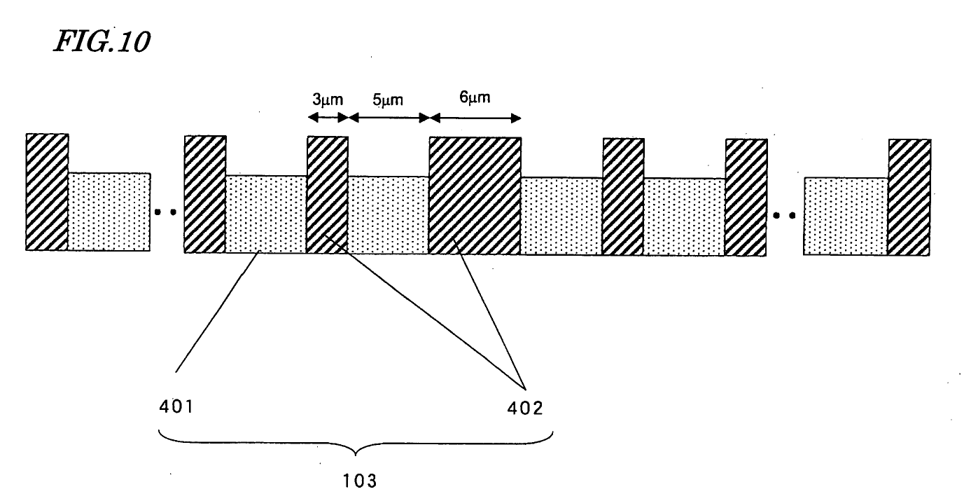

FIG. 10 is a cross-sectional view of the waveguide with those grooves as viewed on a plane that is parallel to the length direction of the waveguide. A difference in equivalent refractive index is made between portions 401 with the grooves (having an equivalent refractive index of 2.097) and portions 402 with no grooves (having an equivalent refractive index of 2.146), thereby defining the periodic structure 103.

As shown in FIG. 7, a modulating electrode 104 is provided on the substrate 101. The modulating electrode 104 includes two lines 104a and 104b, extending along the respective waveguide branches 102a and 102b of the optical waveguide 102, and a grounded electrode 106. This modulating electrode is designed so as to function as a parallel coupled line and produce an odd-mode excitation. The two lines 104a and 104b are arranged such that the internal edge of each of these two lines 104a and 104b is located almost right over the centerline of its associated waveguide branch 102a or 102b. These lines 104a and 104b of the modulating electrode 104 are formed by processing a film of aluminum, gold or any other suitable metal by an evaporation process, a photolithographic process and an etching process, for example.

The narrower the gap between the two lines 104a and 104b of the modulating electrode 104, the higher the electric field to be applied to the waveguide. Meanwhile, if the gap between the two waveguide portions were too narrow, then it would be impossible to split the light to propagate through those two portions. That is why the gap between the waveguide branches 102a and 102b with the modulating electrode 104 (i.e., a region where the two waveguide portions are parallel to each other) preferably falls within the range of 5 μm to 20 μm, more preferably 8 μm to 15 μm.

Also, the electric field is preferably applied parallel to the z-axis, which is the principal axis of the dielectric crystals. As long as this condition on the orientation of the crystal substrate and the arrangement of the electrodes is satisfied, various modes can be adopted.

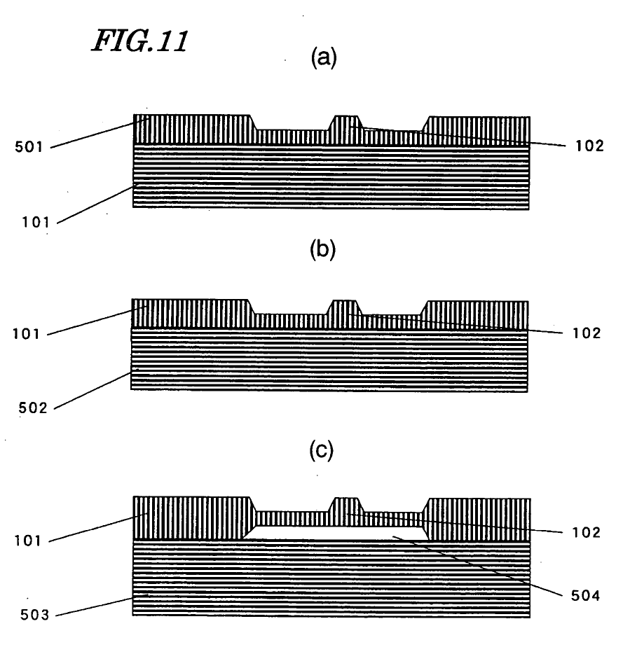

In this preferred embodiment, a difference in refractive index is made perpendicularly to the principal surface of the substrate 101 by diffusing Ti deeper into the substrate 101 and making a layer 501 with the higher refractive index therein as shown in FIG. 11(a). Alternatively, a second substrate 502 with a lower refractive index than the substrate 101 may be bonded to the substrate 101 as shown in FIG. 11(b). As another alternative, the difference in refractive index may also be made by providing an air gap 504 as shown in FIG. 11(c). In the configuration shown in FIG. 11(c), not the second substrate 502 with the lower refractive index but a substrate 503 made of the same material as the substrate 501 may be bonded.

In the configuration shown in FIG. 11(b), the second substrate needs to be made of a material that has a different refractive index from that of the first substrate. On the other hand, in the configuration shown in FIG. 11(c), the second substrate may be made of the same material as the first substrate.

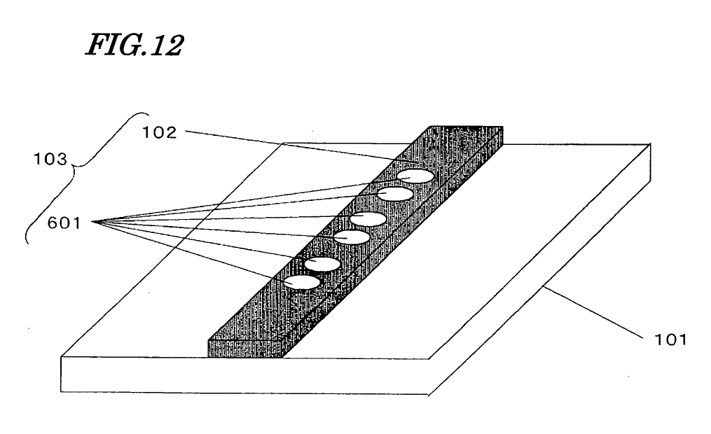

Optionally, instead of changing the equivalent refractive index of selected portions of the waveguide 102 by cutting the grooves in the waveguide 102, the periodic structure 103 may also be defined by boring at least one hole (or recess) 601 in the waveguide 102 as shown in FIG. 12.

Japanese Patent Application Laid-Open Publication No. 2002-196296 discloses an optical modulator including an optical waveguide made of photonic crystals. This optical modulator does not have a structure to confine light perpendicularly to the principal surface of the substrate, and therefore, would allow the light to diffuse toward the depth of the substrate and produce significant attenuation, which is a serious problem.

On the other hand, Japanese Patent Application Laid-Open Publication No. 2002-296628 discloses an all around optical function element having a photonic bandgap structure. This element is made of a compound semiconductor, which can be easily subjected to a fine line patterning process.

Alternative Embodiments of Optical Modulator

In the preferred embodiment described above, various types of recessed portions such as grooves or holes are made on the surface of the optical waveguide. Alternatively, raised portions may also be arranged on the optical waveguide as mentioned above. The periodic structure consisting of the raised portions may be defined by depositing a dielectric film on the principal surface of the substrate 1 and then patterning the dielectric film. The patterned dielectric film has a plurality of holes or grooves that are arranged periodically in the light propagation direction and can make a light wave, propagating through the optical waveguide, sense a variation in equivalent refractive index.

The dielectric film is preferably made of a material with a high dielectric constant. This is because the higher the dielectric constant, the more effectively the group velocity can be reduced.

When the periodic structure is made of such a patterned dielectric film, there is no need to carry out the process step of etching the substrate itself. If the recessed portions such as grooves or holes are cut by etching the substrate, it is difficult to adjust the depth of those recessed portions. However, if a dielectric film deposited on a substrate is patterned, then the dielectric film can be selectively etched by adjusting the etching conditions. Thus, a plurality of raised portions with substantially the same height can be arranged on the substrate with good reproducibility.

Optionally, the structure of which the equivalent refractive index changes periodically may also be defined on the optical waveguide not by making physical unevenness on the optical waveguide but by either thermally diffusing a metal in a selected region of the optical waveguide or subjecting that region to a proton exchange process. In that case, however, the rate of variation in equivalent refractive index is much smaller than a situation where the optical waveguide is etched selectively and periodically. Thus, it is difficult to reduce the group velocity of the light wave significantly.

Suppose a periodic structure, in which grooves are cut periodically so as to reach a depth below the bottom of the optical waveguide and are filled with the air, as a specific example. When the optical waveguide has a refractive index of 2.1, such a periodic structure has a refractive index of about 1 inside of those grooves. Thus, the amplitude of the variation in the refractive index of the periodic structure (i.e., a value normalized with the maximum refractive index) becomes about 0.5. However, the amplitude of the periodic variation in refractive index can be adjusted to an arbitrary value of less than 0.5 by either decreasing the depth of the grooves or filling the grooves with an appropriate dielectric material. On the other hand, if the refractive index is varied periodically by thermally diffusing a metal, for example, then the periodic variation in refractive index has a small amplitude of about 0.001 to about 0.01.

In the preferred embodiments described above, the substrate is made of a material with an electro-optic effect such as lithium tantalate crystals or lithium niobate. Alternatively, any other electro-optic crystals may be used instead.

In the preferred embodiments described above, the optical waveguide is built in the substrate by thermally diffusing metal titanium in the surface region of an electro-optic crystal substrate. This is one of the most effective methods of making a high-performance optical waveguide. However, it is not always necessary to adopt this method. For example, if a substrate made of a material other than lithium niobate single crystals needs to be used to integrate this optical modulator with another functional element together, then a film of a material that has a higher refractive index than the substrate and has an electro-optic effect may be provided on the substrate and used as the optical waveguide.

Optionally, a core portion that has a higher refractive index than its surrounding region may be defined in a surface region of the substrate and a film of a material with an electro-optic effect may be provided as a cladding portion. Then, optical modulation may be achieved by varying the refractive index of the cladding portion with an electric field leaking out of the core portion.

Embodiment of Communications System

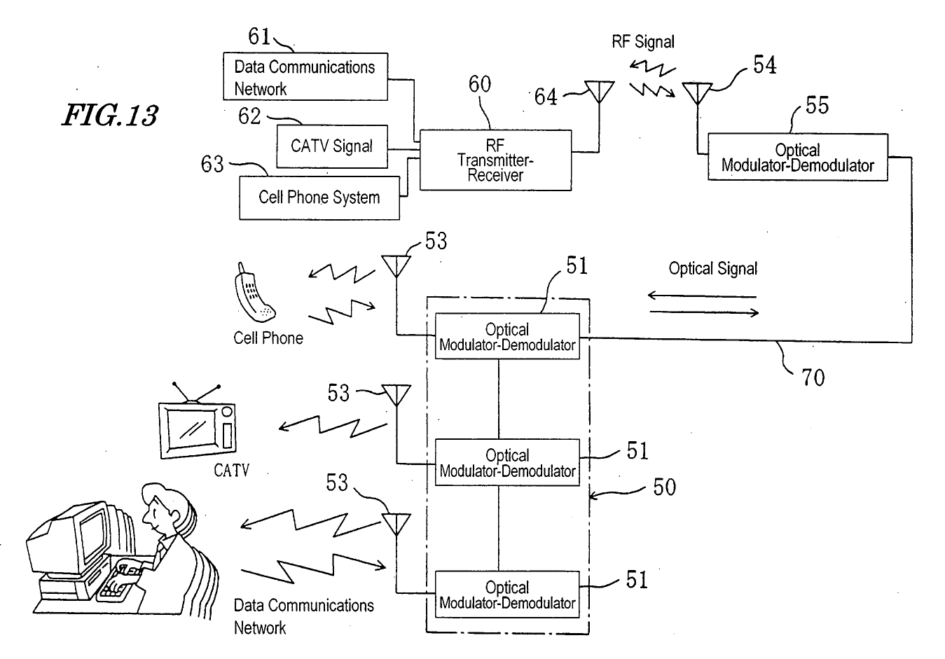

Next, a preferred embodiment of a fiber optics transmission system according to the present invention will be described with reference to FIG. 13. The fiber-optics transmission system 50 of this preferred embodiment includes multiple optical modulators-demodulators 51, each including the optical modulator of the preferred embodiment of the present invention described above. In this transmission system, RF signals may be directly received from, or transmitted to, a data communications network such as the Internet, various mobile electronic devices such as cell phones, or a CATV network through antennas 53. These communications can be carried out on a carrier wave such as the milliwave. Each of those optical modulators-demodulators 51 includes not only the optical modulator but also an optical demodulator (such as a photodiode).

However, an RF signal having a high frequency falling within the milliwave band, for example, is normally hard to transfer completely over a long distance and is often blocked by some objects. Accordingly, communications with the data communications network 61, CATV network 62 or cell phone system 63 may also be carried out by way of an RF transmitter-receiver 60 including an antenna 64. In that case, an optical modulator-demodulator 55 with an antenna 54 needs to be connected to the fiber-optics transmission system 50 through fiber-optics bundles 70. Then, signals can be exchanged with the RF transmitter-receiver 60 by way of the antennas 54 and 64 and the optical modulator-demodulator 55. The optical modulator-demodulator 55 includes not only the optical modulator but also an optical demodulator (such as a photodiode).

In transmitting an optical signal either over a long distance or indoors through building walls, the optical signal is preferably modulated with an RF signal falling within the milliwave band, for example, before propagating through the fiber-optics bundles 70.

According to the present invention, the periodic structure reduces the group velocity of light waves, thereby increasing the modulation efficiency of the optical modulator. By applying an optical modulator according to the present invention to a communications system, communications can be carried out using a modulating electric signal falling within the milliwave band.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2003-182115 filed Jun. 26, 2003 and No. 2003-393627 filed Nov. 25, 2003 the entire contents of which are hereby incorporated by reference.

1. An optical modulator comprising an optical waveguide made of a material with an electro-optic effect and a modulating electrode for applying a modulating electric signal to light propagating through the optical waveguide,
wherein the optical waveguide is defined on an electro-optic crystal substrate,
wherein the optical waveguide is defined as a ridge on the surface of the electro-optic crystal substrate, and
wherein the modulator further includes a periodic structure, of which the equivalent refractive index changes periodically in a light propagation direction and which reduces a group velocity of the light propagating through the optical waveguide.

2. The optical modulator of claim 1, wherein the periodic structure is defined by a plurality of recessed portions and/or raised portions that are provided on the surface of the optical waveguide.

3. The optical modulator of claim 2, wherein the periodic structure is defined by a plurality of grooves cut on the surface of the optical waveguide.

4. The optical modulator of claim 2, wherein the periodic structure is defined by a plurality of holes bored on the surface of the optical waveguide.

5. The optical modulator of claim 3, wherein the number of the grooves or the holes made on the optical waveguide is 100 or more.

6. The optical modulator of claim 3, wherein the depth of the grooves or the holes is at most 50% of the thickness of the waveguide.

7. The optical modulator of claim 1, wherein the periodic structure is coated with a dielectric film.

8. The optical modulator of claim 1, wherein the periodic structure is defined by a pattern of a dielectric film provided on the optical waveguide.

9. The optical modulator of claim 1, wherein the periodic structure includes
a first region and a second region, which are arranged in series in the light propagation direction, and
an intermediate region, which is located between the first and second regions.

10. The optical modulator of claim 1, wherein a period in which the equivalent refractive index of the periodic structure changes in the light propagation direction is either a numerical value that is a quarter to a half as long as the wavelength λ of the light to be modulated in the optical waveguide or a product of the numerical value and an odd number.

11. The optical modulator of claim 10, wherein the length of the intermediate region as measured in the light propagation direction is either approximately ½ λ or an integral multiple of ½λ.

12. The optical modulator of claim 1, wherein the optical waveguide includes:
an optical input portion to input the light to be modulated;
an optical output portion to output the modulated light; and
at least two waveguide branches that couple the optical input and output portions together, and
wherein the modulating electrode includes at least two conductor lines for applying the modulating electric signal to the light propagating through the respective waveguide branches, and
wherein the intensity of the light is modulated by utilizing the interference of the light, which has propagated through the respective waveguide branches, at the optical output portion.

13. The optical modulator of claim 1, wherein the optical waveguide is a single optical waveguide with one end to input the light to be modulated and the other end to output the modulated light, and
wherein the modulating electrode includes at least two conductor lines for applying the modulating electric signal to the optical waveguide, and
wherein the phase of the light that has propagated through the optical waveguide is modulated according to the modulating electric signal.

14. The optical modulator of claim 1, wherein the optical waveguide is made of an electro-optic material supported on a substrate.

15. The optical modulator of claim 1, wherein the group velocity of the light propagating through the optical waveguide is adjusted to 0.5 to 2 times as high as the phase velocity of a radio frequency wave transmitted through the electrode.

16. The optical modulator of claim 1, wherein the group velocity of the light propagating through the optical waveguide is reduced to 50% or less of that of the light propagating through an optical waveguide without the periodic structure.

17. A communications system comprising:
the optical modulator of claim 1;
an optical fiber for transmitting the modulated light that has been output from the optical modulator; and
means for supplying the modulating electric signal to the optical modulator.

18. The optical modulator of claim 1, wherein to confine the light vertically to the principal surface of the electro-optic crystal substrate, the optical waveguide is designed as a region with an increased refractive index as compared with other regions.

19. The optical modulator of claim 1, wherein an air gap is provided right under the optical waveguide.

20. An optical modulator comprising an optical waveguide made of a material with an electro-optic effect and a modulating electrode for applying a modulating electric signal to light propagating through the optical waveguide,
wherein the modulator further includes a periodic structure, of which the equivalent refractive index changes periodically in a light propagation direction and which reduces a group velocity of the light propagating through the optical waveguide to 1/500 or less.
